(19) United States
(12) Patent Application Publication
(10) Pub. No.: US 2025/0266656 A1
(43) Pub. Date: Aug. 21, 2025

(54) HYBRID OPTICAL AMPLIFIER

(71) Applicant: Fujitsu Limited, Kawasaki-shi (JP)

(72) Inventor: Youichi AKASAKA, Plano, TX (US)

(73) Assignee: Fujitsu Limited, Kawasaki-shi (JP)

(21) Appl. No.: 18/582,112

(22) Filed: Feb. 20, 2024

(51) Int. Cl. H01S 3/067; H01S 3/094; H01S 3/16; H01S 3/30

(52) U.S. Cl. CPC H01S 3/06758; H01S 3/06775; H01S 3/094096; H01S 3/1608; H01S 3/302

(57) ABSTRACT

According to an aspect of an embodiment, a hybrid optical amplifier may include an erbium doped fiber amplifier (EDFA) that includes multiple EDFA stages. The hybrid optical amplifier may also include a Raman amplifier inserted between two of the EDFA stages.

### FIELD

The embodiments discussed in the present disclosure are related to hybrid optical amplifiers.

### BACKGROUND

Telecommunications systems, cable television systems and data communication networks use optical networks to convey information between remote points. In an optical network, information is conveyed in the form of optical signals through optical fibers or other optical media. The optical networks may include various components such as amplifiers, dispersion compensators, multiplexer/demultiplexer filters, wavelength selective switches, couplers, etc. configured to perform various operations within the optical network. Further, optical amplification may be used to amplify optical signals that propagate through optical networks.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a hybrid optical amplifier may include an erbium doped fiber amplifier (EDFA) that includes multiple EDFA stages. The hybrid optical amplifier may also include a Raman amplifier inserted between two of the EDFA stages.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates an example embodiment of a hybrid optical amplifier;

FIG. 2 illustrates another example embodiment of a hybrid optical amplifier;

FIG. 3 illustrates another example embodiment of a hybrid optical amplifier;

FIG. 4 is a flow chart of an example method of performing amplification with respect to an optical signal using a hybrid optical amplifier; and

FIG. 5 illustrates a block diagram of an example computing system that may be used with a hybrid optical amplifier, all arranged in accordance with some embodiments of the present disclosure.

### DESCRIPTION OF EMBODIMENTS

Optical networks may include nodes that may be configured to communicate information to each other via optical signals carried by optical fibers. In some circumstances, amplification of the optical signals within the optical fibers may enable the optical signals to travel a greater distance by compensating for losses that may affect the optical signal, such as degradations of the optical signal due to a noisy channel within the optical networks.

Amplification of optical signals within an optical network may be obtained using erbium doped fiber amplifiers (EDFAs) in some instances. However, the gain profile of EDF amplification may be dependent on certain wavelength bands. As such, EDFAs may be limited with respect to performing consistent amplification with respect to certain wavelength bands. For example, EDF amplification may vary between the C-band of optical communications (e.g., frequencies having wavelengths approximately between 1525 nanometers (nm) and 1565 nm), the L-band of optical communications (e.g., frequencies having wavelengths approximately between 1565 nm and 1605 nm), and the S-band of optical communications (e.g., frequencies having wavelengths approximately between 1485 nm and 1525 nm).

Alternatively or additionally, some optical amplifiers may be configured to produce Raman gain (referred to as a “Raman amplifier”) as part of the amplification. In some instances, Raman amplifiers may be able to produce wider band amplification than EDFA's. As such, Raman amplifiers may be used for amplification outside of EDFA specific bands. In particular, the amplification process for Raman amplifiers may be based on Raman scattering, where incident optical signals interact with the vibrational modes of the optical fiber, facilitating the transfer of energy to the signal photons. Such scattering may result in the amplification of the optical signals across a broad range of wavelengths. However, as compared to EDFA's, Raman amplifiers may have worse noise characteristics and/or worse fiber nonlinearity characteristics.

Some optical systems perform optical amplification by placing a Raman amplifier at a discrete segment of an optical fiber (referred to in the present disclosure as a “discrete Raman amplifier”) either before or after an EDFA in an attempt to increase the overall amplification bandwidth. However, placing a discrete Raman amplifier before the EDFA may increase the amount of noise that may be input to and amplified by the EDFA and thus may result in poor noise-related performance. Further, placing a discrete Raman amplifier right after the EDFA may result in increased nonlinear distortion created by the discrete Raman amplifier due to the input signal of the discrete Raman amplifier having a relatively high signal power.

According to one or more embodiments of the present disclosure, a hybrid optical amplifier (“hybrid amplifier”) may be created to take advantage of the positive aspects of using EDFAs and Raman amplifiers together while also reducing the negative effects. In particular, as described in detail in the present disclosure, the hybrid amplifier may include an EDFA that includes multiple EDFA stages. Additionally or alternatively, the hybrid amplifier may include a discrete Raman amplifier that is inserted between two of the EDFA stages. Such a configuration may allow for the Raman amplifier to amplify signals outside of the EDFA bandwidth while reducing the amount of noise added by the Raman amplifier and also reducing the non-linear effects that may be added by the Raman amplifier.

Embodiments of the present disclosure will be explained with reference to the accompanying drawings.

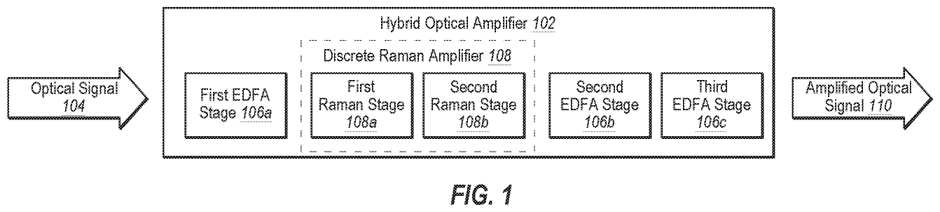

FIG. 1 illustrates an example embodiment of a hybrid optical amplifier 102 (“hybrid amplifier 102”), in accordance with at least one embodiment of the present disclosure. In general, the hybrid amplifier 102 may be configured to amplify an optical signal 104 to generate an amplified optical signal 110. The hybrid amplifier 102 may be included in any suitable optical device or network.

The optical signal 104 may include any optical signal configured to carry data. For example, the optical signal 104 may include an optical signal generated by a light emitting diode (LED), a laser such as a laser diode, having data modulated thereon and/or other similar optical signals. In some embodiments, the optical signal 104 may be generated by a transmitting source, such as an optical transmitter, configured to convey data and/or information over an optical network.

In some embodiments, the optical signal 104 may include a wavelength division multiplexing (WDM) signal that may include multiple beams that each correspond to different wavelength ranges. Additionally or alternatively, the different wavelength ranges may correspond to different optical signal communication bands.

For example, in some embodiments, the optical signal 104 may include a first sub-signal corresponding to a first wavelength range, a second sub-signal corresponding to a second wavelength range, a third sub-signal corresponding to a third wavelength range, and/or a fourth sub-signal corresponding to a fourth wavelength range. In some embodiments, the first wavelength range may correspond to what may be commonly referred to as the C-band of optical signal communications, which may be approximately 1525 nm to 1565 nm. In these and other embodiments, the second wavelength range may correspond to what may be commonly referred to as the L-band of optical signal communications, which may be approximately 1565 nm to 1605 nm. Additionally or alternatively, the third wavelength range and the fourth wavelength range may correspond to one or more bands that may be outside of the C-band or the L-band. For example, the third wavelength range may correspond to what may be commonly referred to as the S-band of optical signal communications, which may be approximately 1485 nm to 1525 nm. Additionally or alternatively, the fourth wavelength range may correspond to what may be commonly referred to as the U-band of optical signal communications, which may be approximately 1605 nm to 1645 nm.

In these and other embodiments, the optical signal 104 may have one or more polarization states. For example, in some embodiments, one or more sub-signals of the optical signal 104 may be oriented according to a first polarization and one or more sub-signals of the optical signal 104 may be oriented according to a second polarization. In these and other embodiments, the first polarization may be orthogonal to the second polarization. For example, the first polarization may correspond to an x-polarization and the second polarization may correspond to a y-polarization that is perpendicular to the x-polarization.

In some embodiments, the hybrid amplifier 102 may include a first EDFA stage 106a, a second EDFA stage 106b, and a third EDFA stage 106c, which may collectively be referred to an EDFA 106 and/or the EDFA stages 106. The EDFA stages 106 may be individually configured to provide a gain to the optical signal 104 such that the power of the optical signal 104 may increase in a cumulative manner as the optical signal 104 passes through the EDFA stages 106.

For example, the first EDFA stage 106a may be the initial EDFA stage that receives and amplifies the optical signal 104. The second EDFA stage 106b may be the next EDFA stage after the first EDFA stage 106a and may apply additional amplification to the optical signal 104 after amplification by the first EDFA stage 106a. Additionally or alternatively, the third EDFA stage may be the next EDFA stage after the second EDFA stage 106b and may apply additional amplification to the optical signal 104 after amplification by the first EDFA stage 106a and the second EDFA stage 106b.

The hybrid amplifier 102 may also include a discrete Raman amplifier 108 (“Raman amplifier 108”). The Raman amplifier 108 may be inserted between two of the EDFA stages 106. For example, in some embodiments, the Raman amplifier 108 may be disposed between the first EDFA stage 106a and the second EDFA stage 106b.

The Raman amplifier 108 may be configured to apply a Raman gain to optical signals that may be received by the Raman amplifier 108. For example, the Raman amplifier 108 may be configured to receive the optical signal 104 after the optical signal 104 has been amplified by the first EDFA stage 106a and may apply the Raman effect to at least a portion of the received optical signal 104. In these and other embodiments, the Raman amplifier 108 may be configured to output the optical signal 104, as amplified using the Raman effect, and provide such signal as an input to the second EDFA stage 106b. As such, the optical signal 104 may be received by the second EDFA stage 106b after being amplified by both the first EDFA stage 106a and the Raman amplifier 108.

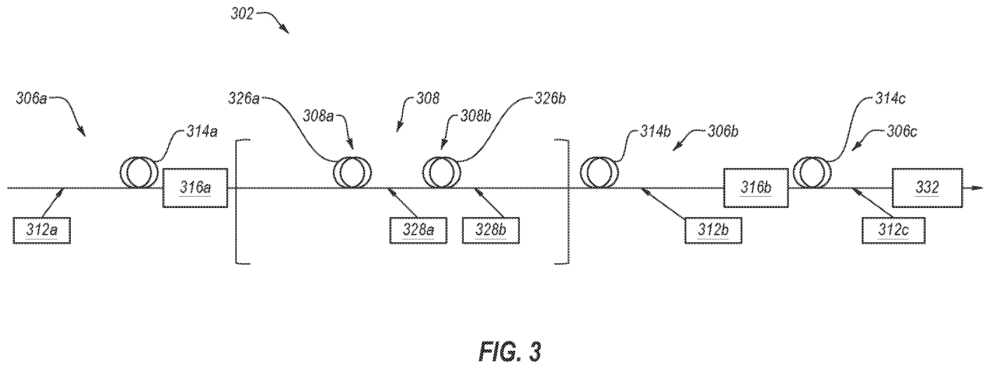

In some embodiments, the Raman amplifier 108 may be configured to apply the Raman effect to all of the optical signal 104 as received after amplification by the first EDFA stage 106a. Additionally or alternatively, the Raman amplifier 108 may be configured such that sub-signals of the optical signal 104 that correspond to certain wavelengths may bypass the Raman amplification. For example, in some embodiments, the Raman amplifier 108 may be configured such that sub-signals of the optical signal 104 that correspond to the first wavelength range and/or the second wavelength range (e.g., frequencies having wavelengths within the C-band and/or the L-band) may bypass the Raman amplification. An example embodiment is discussed in further detail in the present disclosure with respect to FIG. 3

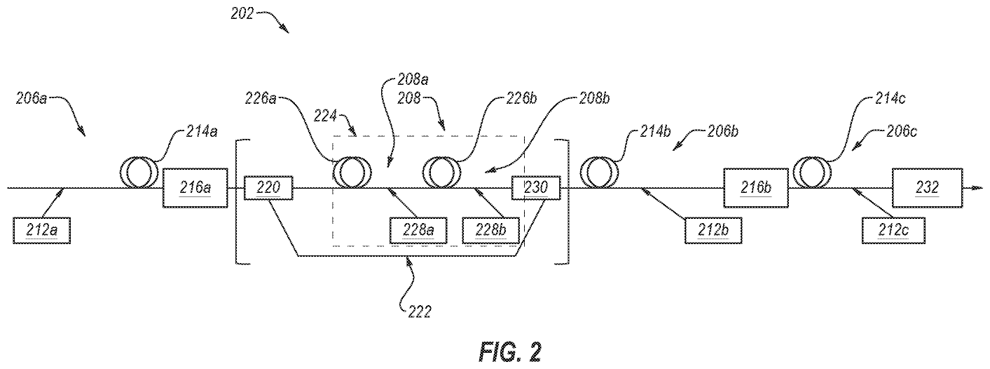

In some instances, certain components (e.g., dispersion compensating optical fibers “DCF”) used for Raman amplification may be polarization dependent in that such components may affect signals having different polarizations differently. As such, in some embodiments to help account for this, the Raman amplifier 108 may include multiple stages that may respectively correspond to different polarizations. For example, the Raman amplifier 108 may include a first Raman stage 108a and a second Raman stage 108b. In these and other embodiments, the first Raman stage 108a may correspond to the first polarization corresponding to the optical signal 104 and the second Raman stage 108b may correspond to the second polarization corresponding to the optical signal 104. Additional examples and details with respect to the Raman stages 108 are discussed further in the present disclosure with respect to FIGS. 2 and 3.

Modifications, additions, or omissions may be made to FIG. 1 without departing from the scope of the present disclosure. For example, the Raman amplifier 108 may be placed between other EDFA stages other than the initial EDFA stage and the next EDFA stage after the initial EDFA stage. However, it is noted that disadvantages associating with placing a Raman amplifier prior to an EDFA, such as discussed above, may be increased the further down the EDFA chain the Raman amplifier 108 is placed.

Further, the EDFA stages 106 may have similar to the same configurations and/or one or more EDFA stages 106 may differ. For example, as discussed in further detail below, in some embodiments, one or more EDFA stages 106 may include respective pump sources. In these and other embodiments, the wavelengths corresponding to two or more of the pump sources may be the same or may vary. The selections of the different pump sources may be based on noise and/or gain profiles. Example embodiments are described in further detail with respect to FIGS. 2 and 3.

Additionally or alternatively, the hybrid amplifier 102 may be configured for specific wavelength ranges. For example, in some embodiments, the hybrid amplifier 102 may be configured to provide amplification to frequencies that correspond to the C-band, the L-band, and the S-band, such as described with respect to FIG. 2. Additionally or alternatively, the hybrid amplifier 102 may be configured to provide amplification to frequencies that correspond to just the S-band. In these and other embodiments, the hybrid amplifier 102 may be configured to provide amplification to one or more other frequencies (e.g., those that correspond to the U-band).

FIG. 2 illustrates an example embodiment of a hybrid optical amplifier 202 (“hybrid amplifier 202”), in accordance with at least one embodiment of the present disclosure. In general, the hybrid amplifier 202 may be configured to amplify an optical signal to generate an amplified optical signal and may be an example of the hybrid amplifier 102 of FIG. 1. In some embodiments, the optical signal may be a WDM signal having multiple sub-signals that correspond to different frequency and corresponding wavelength ranges, such as the optical signal 104 of FIG. 1. The hybrid amplifier 202 may be included in any suitable optical device or network. Additionally or alternatively, the hybrid amplifier 202 may be configured as a C-band, L-band, and S-band amplifier (“S-C-L amplifier”), as detailed below.

In some embodiments, the hybrid amplifier 202 may include a first EDFA stage 206a, a second EDFA stage 206b, and a third EDFA stage 206c, which may collectively be referred to an EDFA 206 and/or the EDFA stages 206. The EDFA 206 may illustrate an example implementation of the EDFA 106 of FIG. 1.

The first EDFA stage 206a may be configured to receive the optical signal and direct the optical signal toward a first EDF 214a. The first EDF 214a may be an erbium-doped optical fiber that is includes erbium ions embedded therein. The erbium ions may become excited by a pumping beam that may be injected into the first EDF 214a via a pump source 212a. When the erbium ions are excited by the pumping beam, they absorb energy and move to higher energy levels. As these excited erbium ions return to their lower energy states, they release energy in the form of photons at longer wavelengths, which may then provide amplification to the optical signal that is travelling through the first EDF 214a.

In some embodiments, the first EDF 214a may have a certain length that may correspond to a target amount of gain and/or gain bandwidth. The particular type of EDF (e.g., the Er dopant concentration) may also be such that the amount of gain and/or gain bandwidth may vary for the same length of different types of EDFs. Additionally or alternatively, the amount of gain and/or the gain bandwidth may vary for different lengths and/or EDF types depending on the pumping beam wavelength. As such, such factors may be considered and/or modified to achieve a target amount of gain and/or to achieve a target gain bandwidth. For example, in some embodiments, the first EDF 214a may have a length of 2.5 meters, which may be based on the type of EDF and the target amount of amplification for the first EDFA stage 206a.

In some embodiments, the pump source 212a may include a light source generator that may be configured to produce the pumping beam. For example, the pump source 212a may include a laser device that may be configured to produce and/or output the pumping beam.

The pump source 212a may be configured to generate the pumping beam to have a particular wavelength (also referred to as operating at the particular wavelength). The particular wavelength may be selected based on one or more amplification effects that may correspond to certain wavelengths. For example, a pumping beam corresponding to a 980 nm wavelength may have relatively good noise performance (e.g., may not create lots of noise) but may provide a more limited gain. By contrast, a pumping beam corresponding to a 1480 nm wavelength may have worse noise performance as compared to a 980 nm wavelength but may provide greater gain. In the present example of FIG. 2, the pumping wavelength corresponding to the pump source 212a may be 980 nm, which may also be referred to as the pump source 212a operating at a pumping wavelength of 980 nm. Such a selection may be based on balancing not introducing noise into the optical signal early in the amplification provided by the hybrid amplifier 202 to reduce the amount of noise that may be amplified by later stages of the hybrid amplifier 202.

In these and other embodiments, the pump source 212a may be configured such that the resulting pumping beam may be a high-power pumping beam. For example, the pumping beam may include a power of at least 20 decibel-milliwatts (dBm).

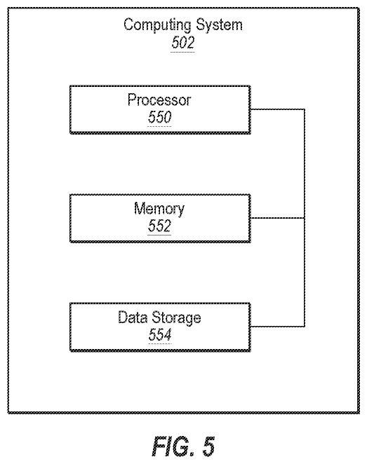

Additionally or alternatively, in some embodiments, the pump source 212a may be controlled using a computing system such as the computing system described below with respect to FIG. 5 of the present disclosure. For example, the computing system may be used to control or select the wavelength corresponding to the pumping beam.

In some embodiments, the hybrid amplifier 202 may include a filter 216a. The filter 216a may include any suitable component that is configured to filter out certain wavelengths in some embodiments. For example, in some instances the amplification that may be created by the first EDFA stage 206a may be substantially higher for sub-signals of the optical signal corresponding to a first wavelength range (e.g., the C-band and/or the L-band) than sub-signals corresponding to a second wavelength range (e.g., the S-band). In these and other embodiments, the filter 216a may be configured to filter signals corresponding to the first wavelength range more than those corresponding to the second wavelength range to help avoid gain saturation of the first wavelength range due to gain saturation of the first wavelength range possibly limiting gain being provided to the second wavelength range.

In some embodiments, the filter 216a may be a static filter that may have a fixed frequency response. Reference to a “fixed frequency response” accounts for unintended drift of the frequency response due to certain conditions and is meant to convey a frequency response that is not readily adjustable and is not meant to refer to a frequency response that is absolutely unmoving. Additionally or alternatively, the filter 216a may be a dynamic filter that may have an adjustable frequency response. In some embodiments, one or more of the adjustment operations may be performed or directed by a computing system such as that described with respect to FIG. 5.

Additionally or alternatively, the hybrid amplifier 202 may also include a discrete Raman amplifier 208 (“Raman amplifier 208”). The Raman amplifier 208 may be disposed after the first EDFA stage 206a and before the second EDFA stage 206b, which may be the next EDFA stage after the first EDFA stage 206a. As such, the Raman amplifier 208 may be configured to apply amplification after that provided by the first EDFA stage 206a but before that provided by the second EDFA stage 206b.

As indicated above, sub-signals corresponding to the second wavelength range may be amplified less by the first EDFA stage 206a (and/or less by one or more subsequent EDFA stages 206) than those corresponding to the first wavelength range. As such, in the illustrated example of FIG. 2, the hybrid amplifier 202 may be configured to separate the sub-signals corresponding to the second wavelength range from those corresponding to the first wavelength range prior such that the first wavelength range bypasses amplification.

For example, the hybrid amplifier 202 may include a demultiplexer 220. The demultiplexer 220 may be configured to separate one or more first sub-signals corresponding to the first wavelength range from one or more second sub-signals corresponding to the second wavelength range.

Additionally or alternatively, the hybrid amplifier 202 may include a first optical path 222 optically coupled to the demultiplexer 220. The first optical path 222 may bypass the Raman amplifier 208. In these and other embodiments, the first optical path 222 may be configured to receive the first sub-signals such that the first sub-signals bypass amplification by the Raman amplifier 208.

Additionally or alternatively, the hybrid amplifier 202 may include a second optical path 224 also optically coupled to the demultiplexer 220. The second optical path 224 may be configured to receive the second sub-signals. Additionally or alternatively, the second optical path 224 may include the Raman amplifier 208 such that the Raman amplifier 208 receives and amplifies the second sub-signals.

In the illustrated example, the Raman amplifier 208 may include a first Raman stage 208a and a second Raman stage 208b. In these and other embodiments, the first Raman stage 208a may correspond to a first polarization and the second Raman stage 208b may correspond to the second polarization.

For example, the first Raman stage 208a may include a first DCF 226a and the second Raman stage 208b may include a second DCF 226b (generally referred to as “DCF's 226”). The first DCF 226a may be configured such that it provides a better gain profile with respect to the first polarization than the second polarization. Additionally or alternatively, the second DCF 226b may be configured such that it provides a better gain profile with respect to the second polarization than the first polarization.

The first Raman stage 208a may include a first pump source 228a and the second Raman stage 208b may include a second pump source 228b (generally referred to as “pump sources 228”). The pump sources 228 may be configured to generate pumping beams in a similar manner to that described with respect to the pump source 212a. Additionally or alternatively, the pumping beams respectively generated by the first pump source 228a and the second pump source 228b may be injected in the first DCF 226a and the second DCF 226b respectively to help provide the Raman amplification within the DCF's 226.

The pump sources 228 may be configured to generate their respective pumping beams to have particular wavelengths. The particular wavelengths may be selected based on one or more amplification effects that may correspond to certain wavelengths. In some embodiments, the particular wavelengths corresponding to the pump sources 228 may be the same. Additionally or alternatively, the particular wavelengths corresponding to the pump sources 228 may differ. For example, such as illustrated in FIG. 2, the first pump source 228a may correspond to a 1400 nm wavelength and the second pump source 228b may correspond to a 1410 nm wavelength. In some embodiments, the differences in the wavelengths may be to reduce interference of amplification of one polarization due to amplification of the other polarization.

As illustrated in FIG. 2, the first Raman stage 208a and the second Raman stage 208b may be disposed in a cascading manner such that the second sub-signals may be amplified by the first Raman stage 208a and then amplified by the second Raman stage 208b. The order as to which polarization corresponds to which Raman stage 208 may vary depending on specific implementations.

The hybrid amplifier 202 may include a multiplexer 230 in some embodiments. The multiplexer 230 may be disposed after the Raman amplifier 208 such as illustrated and may be optically coupled to the first optical path 222 and the second optical path 224. The multiplexer 230 may be configured to recombine the first sub-signals and the second sub-signals after amplification of the second sub-signals by the Raman amplifier 208.

In the illustrated example, the recombined optical signal that may be amplified at this point by the first EDFA stage 206a and the Raman filter 208 may be received by the second EDFA stage 206b. The second EDFA stage 206b may include a second EDF 214b that may be similar or analogous to the first EDF 214a of the first EDFA stage 206a. In these and other embodiments, the second EDF 214b may be a substantially same length as the first EDF 214a. Additionally or alternatively, the second EDF 214b may have a different length than the first EDF 214a. For example, the second EDF 214b may have a length of 3 meters while the first EDF 214a may have a length of 2.5 meters. The length difference may correspond to different target gains and/or gain bandwidths for the first EDFA stage 206a and the second EDFA stage 206b and/or may correspond to different types of EDFs being used for the two stages.

In these and other embodiments, the second EDFA stage 206b may include a pump source 212b that may be similar or analogous to the pump source 212a. In some embodiments, the wavelength corresponding to the pump source 212b may be the same as that corresponding to the pump source 212a. For example, as illustrated, both the pump source 212a and the pump source 212b may generate respective pumping beams corresponding to 980 nm. Additionally or alternatively, the wavelength corresponding to the pump source 212a and the pump source 212b may differ.

In some embodiments, the second EDFA stage 206b may include a filter 216b. In some embodiments, the filter 216b may be similar or analogous to the filter 216a. Additionally or alternatively, the filter 216b may differ from the filter 216a with respect to its particular frequency response and/or adjustability.

After amplification by the second EDFA stage 206b, the optical signal may be received at the third EDFA stage 206c. The third EDFA stage 206c may include a third EDF 214c that may be similar or analogous to the first EDF 214a of the first EDFA stage 206a and/or the second EDF 214b of the second EDFA stage 206b. In these and other embodiments, the third EDF 214c may be a substantially same length as the first EDF 214a and/or the second EDF 214b. Additionally or alternatively, the third EDF 214c may have a different length than the first EDF 214a and the second EDF 214b.

For example, the third EDF 214c may have a length of 5 meters while the first EDF 214a may have a length of 2.5 meters and the second EDF 214b may have a length of 3 meters. The length difference may correspond to different target gains and/or gain bandwidths for the third EDFA stage 206c as compared to the other EDFA stages, different types of EDFs being used for different EDFA stages, and/or different pump wavelengths being used for different EDFA stages.

In these and other embodiments, the third EDFA stage 206c may include a pump source 212c that may be similar or analogous to the pump sources 212a and 212b. In some embodiments, the wavelength corresponding to the pump source 212c may be the same as that corresponding to the pump source 212a and/or the pump source 212b. Additionally or alternatively, the wavelength corresponding to the pump source 212c may differ from that of the pump source 212a and/or the pump source 212b. For example, as illustrated, both the pump source 212a and the pump source 212b may generate respective pumping beams corresponding to 980 nm while the pump source 212c may generate a pumping beam corresponding to 1480 nm. In some embodiments, the 1480 nm may be selected for the pumping beam because of increased gain that it may provide. Further, by using 1480 nm in the last EDFA stage, the extra noise that may be associated with a 1480 nm pumping beam may be less problematic because no further amplification by the hybrid amplifier 202 may be provided.

In some embodiments, the hybrid amplifier 202 may include a gain equalizing filter 232 configured to receive the optical signal after amplification by the third EDFA stage 206c. The gain equalizing filter 232 may include any suitable component that is configured to filter the optical signal such that the power of the optical signal across the different communication bands (e.g., the C-band, the L-band, and the S-band) is substantially the same. The signal that is output after the gain equalizing filter 232 may be an amplified version of the signal received at the first EDFA stage 206a as cumulatively amplified by the hybrid amplifier 202 via the first EDFA stage 206a, then the Raman amplifier 208, then the second EDFA stage 206b, and then the third EDFA stage 206c.

In some embodiments, the gain equalizing filter 232 may be a static filter that may have a fixed frequency response. Additionally or alternatively, the gain equalizing filter 232 may be a dynamic filter that may have an adjustable frequency response. In some embodiments, one or more of the adjustment operations may be performed or directed by a computing system such as that described with respect to FIG. 5.

Modifications, additions, or omissions may be made to the hybrid amplifier 202 without departing from the scope of the present disclosure. For example, the number of EDFA stages 206 may vary. Further, the placement of the Raman amplifier 208 and/or the number of Raman amplifiers 208 may vary. Further, the hybrid amplifier 202 may include one or more other components that help facilitate the propagation and/or manipulation of the optical signal to obtain the targeted amount of gain. Further, the wavelengths corresponding to the different pump sources, the specific types of optical fibers used, and/or the lengths of different optical fibers may vary depending on specific implementations and design goals.

FIG. 3 illustrates an example embodiment of a hybrid optical amplifier 302 (“hybrid amplifier 302”), in accordance with at least one embodiment of the present disclosure. In general, the hybrid amplifier 302 may be configured to amplify an optical signal to generate an amplified optical signal and may be another example implementation of the hybrid amplifier 102 of FIG. 1. In some embodiments, the optical signal may be a WDM signal having multiple sub-signals that correspond to different frequency and corresponding wavelength ranges, such as the optical signal 104 of FIG. 1. The hybrid amplifier 302 may be included in any suitable optical device or network. Additionally or alternatively, the hybrid amplifier 302 may be configured as an S-band amplifier, as detailed below.

In some embodiments, the hybrid amplifier 302 may include a first EDFA stage 306a, a second EDFA stage 306b, and a third EDFA stage 306c, which may collectively be referred to an EDFA 306 and/or the EDFA stages 306. The EDFA 306 may illustrate another example implementation of the EDFA 106 of FIG. 1. Further, the hybrid amplifier may include a discrete Raman amplifier 308 (“Raman amplifier 308”) disposed between the first EDFA stage 306a and the second EDFA stage 306b.

The first EDFA stage 306a may be substantially similar to the first EDFA stage 206a of FIG. 2. For example, the first EDFA stage 306a may include a pump source 312a substantially similar or analogous to the pump source 212a of FIG. 2 and an EDF 314a substantially similar or analogous to the first EDF 214a of FIG. 2. Further, the first EDFA stage 306a may include a filter 316a substantially similar or analogous to the filter 216a of FIG. 2. However, in the present example embodiment, a difference between the filter 316a and the filter 216a may be that the filter 316a may be configured to filter out frequencies higher than those that correspond to the S-band (e.g., frequencies that correspond to the C-band and the L-band) such that frequencies corresponding to the C-band and the L-band may not pass through to the second EDFA stage 306b. Note that reference to the C-band and the L-band not passing through does not necessarily mean that no single portions of such bands do not pass through. Instead, such reference refers to that such bands are sufficiently attenuated by a target amount.

The Raman amplifier 308 may provide additional amplification to the optical signal after amplification by the first EDFA stage 306a and after the optical signal passes through the filter 316a. In the illustrated example of FIG. 3, the hybrid amplifier 302 may not include separate optical paths like the optical paths 222 and 224 of FIG. 2 because the C and L bands have already been filtered out. As such, the full optical signal that passes through the filter 316a may be received at the Raman amplifier 308 in the illustrated example.

The Raman amplifier 308 may be substantially similar or analogous to the Raman filter 208 of FIG. 2. For example, in some embodiments, the Raman amplifier 308 may include a first Raman stage 308a substantially similar or analogous to the first Raman stage 208a of FIG. 2. For instance, the first Raman stage 308a may include a first DCF 326a substantially similar or analogous to the first DCF 226a of the first Raman stage 208a of FIG. 2. Additionally or alternatively, the first Raman stage 308a may include a first pump source 328a substantially similar or analogous to the first pump source 228a of the first Raman stage 208a of FIG. 2.

Further, the Raman amplifier 308 may include a second Raman stage 308b substantially similar or analogous to the second Raman stage 208b of FIG. 2. For instance, the second Raman stage 308b may include a second DCF 326b substantially similar or analogous to the second DCF 226b of the second Raman stage 208b of FIG. 2. Additionally or alternatively, the second Raman stage 308b may include a second pump source 328b substantially similar or analogous to the second pump source 228b of the second Raman stage 208b of FIG. 2.

The second EDFA stage 306b may be substantially similar to the second EDFA stage 206b of FIG. 2. For example, the second EDFA stage 306b may include a pump source 312b substantially similar or analogous to the pump source 212b of FIG. 2 and an EDF 314b substantially similar or analogous to the second EDF 214b of FIG. 2. Further, the second EDFA stage 306b may include a filter 316b substantially similar or analogous to the filter 216b of FIG. 2. However, like the filter 316a as compared to the filter 216a, a difference between the filter 316b and the filter 216b may be that the filter 316b may be configured to filter out frequencies higher than those that correspond to the S-band.

The third EDFA stage 306c may be substantially similar to the third EDFA stage 206c of FIG. 2. For example, the third EDFA stage 306c may include a pump source 312c substantially similar or analogous to the pump source 212c of FIG. 2 and an EDF 314c substantially similar or analogous to the third EDF 214c of FIG. 2.

In these and other embodiments, the hybrid amplifier 302 may include a gain equalizing filter 332 substantially similar or analogous to the gain equalizing filter 232 of FIG. 2. However, the specific frequency response of the gain equalizing filter 332 may differ from that of the gain equalizing filter 232 based on the hybrid amplifier 302 being configured as an S-band amplifier rather a S-C-L band amplifier like that of FIG. 2. The signal that is output after the gain equalizing filter 332 may be an amplified version of the signal received at the first EDFA stage 306a as cumulatively amplified by the hybrid amplifier via the first EDFA stage 306a, then the Raman amplifier 308, then the second EDFA stage 306b, and then the third EDFA stage 306c.

Modifications, additions, or omissions may be made to the hybrid amplifier 302 without departing from the scope of the present disclosure. For example, the number of EDFA stages 306 may vary. Further, the placement of the Raman amplifier 308 and/or the number of Raman amplifiers 308 may vary. Further, the hybrid amplifier 302 may include one or more other components that help facilitate the propagation and/or manipulation of the optical signal to obtain the targeted amount of gain. Further, the wavelengths corresponding to the different pump sources, the specific types of optical fibers used, and/or the lengths of different optical fibers may vary depending on specific implementations and design goals.

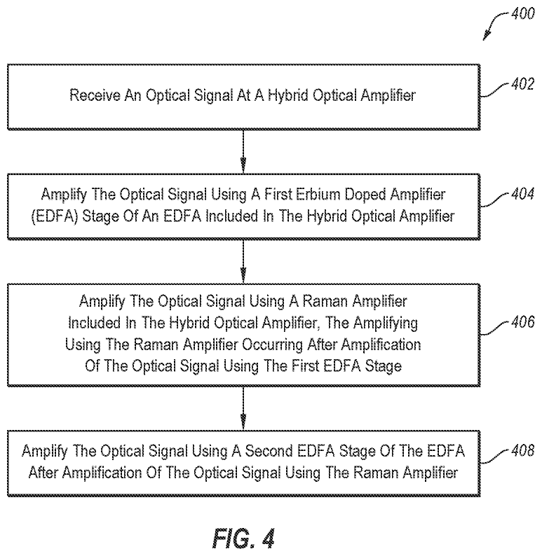

FIG. 4 is a flow chart of an example method 400 of performing amplification with respect to an optical signal using a hybrid optical amplifier, arranged in accordance with at least one embodiment of the present disclosure. One or more operations of the method 400 may be implemented by any suitable element of a hybrid EDFA/Raman optical amplifier such as the hybrid amplifier 102 of FIG. 1, the hybrid amplifier 202 of FIG. 2, and/or the hybrid amplifier 302 of FIG. 3. Although illustrated as discrete steps, various steps of the method 400 may be divided into additional steps, combined into fewer steps, or eliminated, depending on the desired implementation. Additionally, the order of performance of the different steps may vary depending on the desired implementation.

In some embodiments, the method 400 may include a block 402. At block 402, an optical signal may be received at a hybrid optical amplifier. The optical signal 104 of FIG. 1 may be an example of the optical signal and the hybrid amplifier 102 of FIG. 1, the hybrid amplifier 202 of FIG. 2, or the hybrid amplifier 302 of FIG. 3 may be examples of the hybrid amplifier.

At block 404, the optical signal may be amplified using a first erbium doped fiber amplifier (EDFA) stage of an EDFA included in the hybrid optical amplifier. The first EDFA stage 106a of FIG. 1, the first EDFA stage 206a of FIG. 2, and the first EDFA stage 306a of FIG. 3 are examples of the first EDFA stage.

At block 406, the optical signal may be amplified using a Raman amplifier included in the hybrid optical amplifier. The amplifying using the Raman amplifier may occur after amplification of the optical signal using the first EDFA stage, such as described above with respect to one or more of FIGS. 1-3. The Raman amplifier 108 of FIG. 1, the Raman amplifier 208 of FIG. 2, and the Raman amplifier 308 of FIG. 3 are examples of the Raman amplifier.

In some embodiments, the Raman amplifier may include a first Raman stage configured to correspond to a first polarization and a second Raman stage configured to correspond to a second polarization, such as described above with respect to one or more of FIGS. 1-3. Additionally or alternatively, in some embodiments, the first Raman stage may include a first pump source and the second Raman stage may include a second pump source operating at a different pumping wavelength than the first pump source.

At block 408, the optical signal may be amplified using a second EDFA stage of the EDFA. The amplifying of the optical signal using the second EDFA stage may be performed after amplification of the optical signal using the Raman amplifier. In some embodiments, the first EDFA stage is an initial EDFA stage of the EDFA and the second EDFA stage is a next EDFA stage of the EDFA after the first EDFA stage.

Modifications, additions, or omissions may be made to the method 400 without departing from the scope of the present disclosure. For example, one skilled in the art will appreciate that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

Additionally or alternatively, in some embodiments, the EDFA may include more EDFA stages than a first EDFA stage and a second EDFA stage. For example, in some embodiments, the method 400 may include amplifying the optical signal using a third EDFA stage of the EDFA after amplification of the optical signal using the second EDFA stage. Additionally or alternatively, the EDFA stages may include pump sources configured to operate at certain pumping wavelengths. For example, the first EDFA stage may include a first pump source operating at a first pumping wavelength and the second EDFA stage may include a second pump source operating at a second pumping wavelength. In some embodiments, the first pumping wavelength and the second pumping wavelength may be the same and in other embodiments the first pumping wavelength and the second pumping wavelength may be different. Additionally or alternatively, in embodiments in which the EDFA includes a third EDFA stage, the third EDFA stage may include a third pump source operating at a third pumping wavelength. In some embodiments, the third pumping wavelength may be the same as one or more of the first pumping wavelength or the second pumping wavelength. Additionally or alternatively, the third pumping wavelength may be different from both the first pumping wavelength and the second pumping wavelength.

In these and other embodiments, the method may include other operations such as separating first optical signals corresponding to a first wavelength range from second optical signals corresponding to a second wavelength range. In some embodiments, the separating of first sub-signals from second sub-signals by the demultiplexer 220 such as described with respect to FIG. 2 may be an example of the separating.

The operations may further include bypassing amplification of the first optical signals using the Raman amplifier. For instance, the bypassing of the Raman amplifier 202 of FIG. 2 using the first optical path 222 to bypass amplification of the first sub-signals by the Raman amplifier 208 may be an example of the bypassing of amplification of the first optical signals.

Additionally or alternatively, the operations may include amplifying the second optical signals using the Raman amplifier. For instance, the including of the Raman amplifier 202 of FIG. 2 in the second optical path 224 to amplify the second sub-signals by the Raman amplifier 208 may be an example of amplifying the second optical signals.

In these and other embodiments, the operations may include recombining the first optical signals and the second optical signals after amplification of the second optical signals using the Raman amplifier. In some embodiments, the combining of first sub-signals with the second sub-signals by the multiplexer 230 such as described with respect to FIG. 2 may be an example of the combining.

FIG. 5 illustrates a block diagram of an example computing system 502 that may be used with respect to a hybrid optical amplifier, according to at least one embodiment of the present disclosure. For example, the computing system 502 may be used to adjust a pumping wavelength of a pump source of the hybrid optical amplifier (e.g., one or more of the pump sources described above with respect to FIGS. 1, 2, and 3) and/or a frequency response of a filter of the hybrid optical amplifier (e.g., one or more of the filters described above with respect to FIGS. 1, 2, and 3).

The computing system 502 may include a processor 550, a memory 552, and a data storage 554. The processor 550, the memory 552, and the data storage 554 may be communicatively coupled.

In general, the processor 550 may include any suitable special-purpose or general-purpose computer, computing entity, or processing device including various computer hardware or software modules and may be configured to execute instructions stored on any applicable computer-readable storage media. For example, the processor 550 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 5, the processor 550 may include any number of processors configured to, individually or collectively, perform or direct performance of any number of operations described in the present disclosure. Additionally, one or more of the processors may be present on one or more different electronic devices, such as different servers.

In some embodiments, the processor 550 may be configured to interpret and/or execute program instructions and/or process data stored in the memory 552, the data storage 554, or the memory 552 and the data storage 554. In some embodiments, the processor 550 may fetch program instructions from the data storage 554 and load the program instructions in the memory 552. After the program instructions are loaded into memory 552, the processor 550 may execute the program instructions.

The memory 552 and the data storage 554 may include computer-readable storage media for carrying or having computer-executable instructions or data structures stored thereon. Such computer-readable storage media may include any available media that may be accessed by a general-purpose or special-purpose computer, such as the processor 550. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 550 to perform a certain operation or group of operations.

Modifications, additions, or omissions may be made to the computing system 502 without departing from the scope of the present disclosure. For example, in some embodiments, the computing system 502 may include any number of other components that may not be explicitly illustrated or described.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. Additionally, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B” even if the term “and/or” is used elsewhere.

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A hybrid optical amplifier comprising:
an erbium doped fiber amplifier (EDFA) that includes a plurality of EDFA stages; and
a Raman amplifier inserted between two EDFA stages of the plurality of EDFA stages.

2. The hybrid optical amplifier of claim 1, wherein the Raman amplifier is inserted between an initial EDFA stage of the plurality of EDFA stages and a next EDFA stage of the plurality of EDFA stages that is directly after the initial EDFA stage.

3. The hybrid optical amplifier of claim 1, wherein the Raman amplifier includes a first Raman stage configured to correspond to a first polarization and a second Raman stage configured to correspond to a second polarization.

4. The hybrid optical amplifier of claim 3, wherein the first Raman stage includes a first pump source and the second Raman stage includes a second pump source operating at a different pumping wavelength than the first pump source.

5. The hybrid optical amplifier of claim 1, wherein a last EDFA stage of the plurality of EDFA stages includes a first pump source operating at a first pumping wavelength different from a second pumping wavelength corresponding to second pump sources respectively corresponding to the other EDFA stages of the plurality of EDFA stages.

6. The hybrid optical amplifier of claim 5, wherein the first pumping wavelength corresponds to a better noise profile than the second pumping wavelength and the second pumping wavelength corresponds to a better gain profile than the first pumping wavelength.

7. The hybrid optical amplifier of claim 1, further comprising:
a demultiplexer configured to separate first optical signals corresponding to a first wavelength range from second optical signals corresponding to a second wavelength range;
a first optical path optically coupled to the demultiplexer that bypasses the Raman amplifier and that is configured to receive the first optical signals;
a second optical path optically coupled to the demultiplexer that includes the Raman amplifier and that is configured to receive the second sub-signals and amplify the second optical signals via the Raman amplifier; and
a multiplexer disposed after the Raman amplifier and optically coupled to the first optical path and the second optical path, the multiplexer being configured to recombine the first optical signals and the second optical signals after amplification of the second optical signals by the Raman amplifier.

8. The hybrid optical amplifier of claim 7, wherein the first wavelength range includes one or more of a C-band of optical communications or an L-band of optical communications.

9. The hybrid optical amplifier of claim 7, wherein the second wavelength range includes an S-band of optical communications.

10. The hybrid optical amplifier of claim 1, wherein one or more of the EDFA stages respectively include a filter configured to filter out optical signals corresponding to a wavelength range that includes one or more of a C-band of optical communications or an L-band of optical communications.

11. A method comprising:
receiving an optical signal at a hybrid optical amplifier;
amplifying the optical signal using a first erbium doped fiber amplifier (EDFA) stage of an EDFA included in the hybrid optical amplifier;
amplifying the optical signal using a Raman amplifier included in the hybrid optical amplifier, the amplifying using the Raman amplifier occurring after amplification of the optical signal using the first EDFA stage; and
amplifying the optical signal using a second EDFA stage of the EDFA after amplification of the optical signal using the Raman amplifier.

12. The method of claim 11, wherein the first EDFA stage is an initial EDFA stage of the EDFA and the second EDFA stage is a next EDFA stage of the EDFA after the first EDFA stage.

13. The method of claim 11 wherein the Raman amplifier includes a first Raman stage configured to correspond to a first polarization and a second Raman stage configured to correspond to a second polarization.

14. The method of claim 13, wherein the first Raman stage includes a first pump source and the second Raman stage includes a second pump source operating at a different pumping wavelength than the first pump source.

15. The method of claim 11, further comprising amplifying the optical signal using a third EDFA stage of the EDFA after amplification of the optical signal using the second EDFA stage.

16. The method of claim 15, wherein:
the first EDFA stage includes a first pump source operating at a first pumping wavelength;
the second EDFA stage includes a second pump source operating at a second pumping wavelength that is the same as the first pumping wavelength; and
the third EDFA stage includes a third pump source operating at a third pumping wavelength different from the first pumping wavelength and the second pumping wavelength.

17. The method of claim 11, further comprising:
separating first optical signals corresponding to a first wavelength range from second optical signals corresponding to a second wavelength range;
bypassing amplification of the first optical signals using the Raman amplifier;
amplifying the second optical signals using the Raman amplifier; and
recombining the first optical signals and the second optical signals after amplification of the second optical signals using the Raman amplifier.

18. The method of claim 17, wherein the first wavelength range includes one or more of a C-band of optical communications or an L-band of optical communications.

19. The method of claim 17, wherein the second wavelength range includes an S-band of optical communications.

20. The method of claim 11, wherein one or more of the first EDFA stage or the second EDFA stage respectively includes a filter configured to filter out optical signals corresponding to a wavelength range that includes one or more of a C-band of optical communications or an L-band of optical communications.
